(19) United States
(12) Patent Application Publication
(10) Pub. No.: US 2017/0232447 A1
(43) Pub. Date: Aug. 17, 2017

(54) RECYCOIL OPERATING PROCESS

(71) Applicants: THOMAS GERARD FOLLETT, Red Deer (CA); NIGEL CLAIR PISKO, Westerose (CA)

(72) Inventors: THOMAS GERARD FOLLETT, Red Deer (CA); NIGEL CLAIR PISKO, Westerose (CA)

(21) Appl. No.: 15/430,103

(22) Filed: Feb. 10, 2017

Related U.S. Application Data
(60) Provisional application No. 62/294,466, filed on Feb. 12, 2016.

(51) Int. Cl. B02C 25/00; E21B 17/20; B02C 18/06; B02C 23/02; B02C 23/20

(52) U.S. Cl. CPC B02C 25/00; B02C 23/02; B02C 23/20; B02C 18/06; E21B 17/20

(57) ABSTRACT

This invention is aimed at a problem arising in the oil and gas industry, namely disposal of tubing after it has reached ‘end-of-life’. Currently, there is no good way of efficiently reclaiming coil tubing which is no longer useful in the oilfield for production or drilling-related purposes. Instead the tubing is typically stored as junk, or shipped on reels to foundries for remanufacturing. This invention aims to assist in the recycling or reclamation of end-of-life coiled tubing by safely and efficiently turning the tubulars into compact chips or shreds, and may be helpful in the recycling and reclamation of other types of tubing, jointed pipe, pipeline and similar conduit materials.

### FIELD OF THE INVENTION

This invention is aimed at a problem arising in the oil and gas industry, having to do with disposal of coiled tubing strings after they have reached their ‘end-of-life’. Currently, there is no good way of efficiently recycling or reclaiming coil tubing strings which are no longer useful in the oilfield for production or drilling-related purposes, and instead the tubing is typically stored out of the way as junk, or sometimes shipped on reels to foundries for remanufacturing. This invention aims to assist in the recycling or reclamation of end-of-life coiled tubing, and may be helpful in the recycling and reclamation of other types of tubing, jointed pipe, pipeline and similar conduit materials.

### BACKGROUND OF THE INVENTION

Coiled tubing strings reach “end-of-life” (EOL) based upon history of use, number of bending events, deformation, bursting, splices, etc., after which the coiled tubing string is no longer useable in an operation. Different operations will cause different EOL for different types of coiled or endless tubing.

After reaching EOL, the tubing is removed from operations (drilling or completion rig, workover rig, wellbore) and is taken off-site for storage and eventual recycling/destruction. The tubing is supposed to be cleaned and purged to remove any harmful chemicals or substances, both internally and externally. The endless tubing is typically wound onto a wooden reel and moved to a storage yard.

Occasionally, the wooden reels of EOL tubing are taken by truck or transport to a foundry for use as feedstock for the metals foundry's operation. Mostly, the wooden spools of tubing sit in yards in the open, awaiting recycling.

The endless tubing is not easy to move, as the spools are very large and cannot be easily broken into smaller packages for shipment. This constrains the shipping methods available, limiting them to large trailers with large tractor rigs, which because of their bulk (not weight) may also be restricted in the routes available. Thus, it is most often more economical to simply store the EOL tubing where it sits.

### SUMMARY OF THE INVENTION

In an embodiment of the invention, tubing shredding or chipping apparatus is provided which comprises tubing manipulation and receiving means, tube-guiding, aiming and support means, tubing cutting or shredding means, power supplied to the tube manipulation means and power to the cutting or shredding means, control means for the speed at which the tubing is introduced by the manipulation means through the guide and support means to the cutting or shredding means, control means for the guide and support over the direction the tubing is introduced to the cutting or shredding means, means to control the distance from the cutting or shredding means to the guiding and supporting means, and means to control the speed and force of the cutting means applied to the tubing during use of the apparatus to cut/shred the tubing.

In another embodiment, the manipulation means includes gripping means to engage the tubing to be processed, and may also include tubing straightening means, and may include a continuous-belt or chain which is motor driven, with the belt or chain being faced with friction means to engage and manipulate the tubing, and propel the tubing in a continuous operation and direction (toward and against the cutting means).

In another embodiment, the tubing may be removed from its installed location (such as a buried pipeline or conduit) by digging a hole around a part of the tubing at one location, removing a section of the exposed tubing, lowering the process equipment into the hole, attaching the manipulation means to an exposed end of the tubing, cutting the tubing at another location some distance along the attached tubing's length, and then using the manipulation means to both extract the tubing by pulling it from its buried location linearly and manipulating the tubing into the cutting means, turning the tubing into tractable chips or shreds until the cut length of tubing is removed, and the resulting chips are removed, after which the equipment may be removed from the hole and the process can be repeated if required.

### DESCRIPTION OF THE DRAWINGS

FIG. 1 (1a, 1b, 1c) is a set of drawings showing an example of the invention for processing coiled tubing.

FIG. 2 is a set of drawings showing an example of the invention for pulling underground pipe or conduit from its installed setting (for instance as a pipeline or underground utility service) and processing the removed pipe or conduit into chips or particles for removal.

### DETAILED DESCRIPTION OF THE INVENTION

### Problem #1: Tubing is Hard to Ship

Tubing has relatively thin walls, compared with the area of a cross-section of the whole tube, on the order of 2.5:1.0 (for an example 2.0″ OD tubing with 0.208″ wall thickness where the cross-sectional area of the wall is about 1 sq. in. and the cross-sectional area of the tubing's OD is about 2.405 sq. in.). The useful recyclable metal of the tubing is in the wall. The relative space taken up by the tube compared to the space taken up by the metal comprising the wall, means that only about ⅖ths of the tube's volume, standalone, is made up of metal. Less than half (⅖ in this example) of the bare tube's volume is made up of recyclable wall material, while in reality more like 3-7 or 8 (or even higher depending upon the tube's OD) times the actual volume of metal is taken up by space inside the tube or between wraps and layers of the coiled tube and itself, and the spool, when the tubing is spooled for transport. This contrasts with the fact that the density of the metal wall, if shredded and closely packed, would approach 90% of its own volume (if shredded and closely packed without large air gaps and spaces).

This equates to an efficiency gain, for shipment, of about 3-8 (or more) times more metal per comparable volume, and also removes shipping constraints imposed by large-spool methodologies (which may be replaced with conventional hoppers or railcars for transport).

Similar efficiencies are available when comparing the metal-to-volume-required to ship stacked pipe joints. Everyone is familiar with seeing a rack of pipe lengths on a stand in a yard or on a trailer on the highway, and remarking that there is a large volume of ‘air’ compared to the pipe's walls, riding along with the metal. By reducing the pipe to metal chips or shreds, the metal-to-volume ratio changes dramatically, and at least one shipping and handling constraint is removed.

In addition, by making the tubing into small particles of metal, the material becomes much more tractable, easier to handle as a bulk material using conveyors and containers rather than spools and special handling equipment, large and restricted roadways, and the like. The particles can be shipped in a variety of convenient containers, rather than requiring special transport racks, bracing and strapping.

In some embodiments, turning tubular metal into shreds “in situ” can assist in removing large pipe runs from installed pipeline or conduit settings at an extraction site, rather than having to handle large lengths of removed pipe, wrestle it to surface, and ship it away for handling—shredding in situ may make the removal to surface and shipment away from site much simpler and safer, and less expensive.

It is noted that these examples are descriptive and not limiting, and that a skilled person familiar with this type of problem will understand numerous variants which are also part of the invention, without departing from the invention. This detailed description is not intended to limit the broad features or principles of the present invention in any way or to limit the scope of any patent monopoly to be granted. The limits of the invention are instead to be found in the claims.

Problem #2: Turning Continuous Metal (or Composite) Tubing into Shreds

There is no existing mechanism or method for safely and efficiently turning long spools of (so-called) endless tubing into shredded particles. It would also be useful to have the mechanism be amenable for use on segmented tubing such as drill string, fracking iron, pipeline or large-scale conduit runs like sewer, gas and water utility lines being decommissioned or recycled.

### THE INVENTION AS A SOLUTION

The invention described here provides a mechanism and method for turning metal or composite tubing such as coiled tubing for oil industry use (but also other tubing such as jointed drillstem or other pipe or tubing) into tractable chips, using equipment which is robust, fast, safe and transportable to the location of stored or installed tubing products, for example coiled tubing stored in a field as junk after its end-of-life. The shipping problem and the chipping problem may both be solved by use of this equipment and method.

Tubing Manipulation Equipment:

a traction means is required to move the tubing from its repository or a stored position accurately and steadily in a controlled way into the processing machinery and against the active elements of the processing machinery of the invention.

For tubing, and in particular endless tubing, systems of motor-driven belts or chains faced with gripping means to engage with the tubing's outer surface frictionally are convenient, and examples are available from conventional drilling and snubbing equipment, which systems handle and manipulate tubing 5 into and out of holes (and otherwise). The invention would repurpose this type of conventional equipment, in some embodiments, to the new purpose of directing and forcing the tubing 5 for processing into the processing machinery 2, 10, 11 and against the active elements 10 of the processing machinery of the invention. The tubing manipulation equipment 4, 12 may be provided separately from the other components detailed below.

In an embodiment where the tubing for processing is being removed from an installed situation (as a pipeline or underground conduit, for example), the tubing manipulation equipment might include gripping 22 and hydraulic jacking means, 23, 25, 27 to both pull the tubing 28 from its installed setting as an underground conduit and feed it into the processing machinery 21 in a controlled yet powerful enough manner to be operable. This way, the tubing manipulation equipment will also be the pipeline removal/extraction force, and since the removed pipeline is shredded at or near the removal point on the pipeline and since the manipulation equipment's jacks and gripping means can pull long sections of the pipeline from its installed setting, the shreds can be easily removed from the processing equipment; this means that the in situ shredding function assists in removing process complexity and removal/transport bottlenecks and costs from pipeline-removal processes. Instead of handling large segments of pipeline from the hole onto the surface and then onto transport, the removed tubing is shredded in situ, in the hole, and metal chips are removed and transported, which may require much simpler, less complex, and less costly methods (such as simple conveyor belts 20 and hoppers).

Tube-Guiding Equipment:

as the tubing is drawn toward the processing machinery (by the tubing manipulation equipment), it is useful to hold the tubing steady and aim its end toward and to the cutting surfaces of the processing machinery. Ideally, the tube-guiding means 11 will permit the tubing to pass through the guiding-means without undue friction, but will not permit the cutting means to deform the tubing so that its end is deflected away from desirable alignment (usually perpendicular) to the cutting surfaces of the processing equipment. This may be done by a sleeve-like die 11 mounted to hold the tubing steady and aimed at the cutting equipment, 10 the tubing is fed through the die 11 by the tubing manipulation equipment 12 to the cutting 10 head.

Cutting Face:

The tubing is pushed by tube-manipulation equipment (which might be pipeline-pulling jacks and grippers, or the traction equipment mentioned above) through the tube-guide 11 against a cutting face 10. The cutting face is, for example, a heavy rotating milling head 10 with multiple carbide blades aligned and shaped to rotate with the milling head and to cut the tubing's 5 metal wall as the tubing's end is pushed into the path of the rotating cutting blades on the milling head 10. Of note, this is an example of one embodiment, and there are many imaginable cutting face, shearing, grinding, slicing or other means to turn metal tubing into metal chips. The result is the tubing wall being transformed into cut, shredded, sheared or ground shards or particles of metal to a size and shape determined by the milling head and cutting blade size and design, the speed of advancement of the tubing against the head, the tubing's material and wall characteristics and the speed of rotation of the milling head.

Process Machinery Working Chamber:

It is desirable to have the tubing end, the cutting face, milling head and blades, and the chipped material resulting from the cutting operations, isolated from the machine's operator, but it may also be useful or desirable to isolate these things for other reasons, such as to provide cooling or lubricating, or controlling environmental elements (such as removal of oxygen, nitrogen or ammonia, water or other fluid bath), or washing of the resulting metal chips (for example with appropriate solvent or other baths to remove contaminants, or other materials from the chipped tubing material as an end-product) in a sort of isolated chamber (isolated from environment, isolated from operator, or similar), or Working Chamber 2.

Chip-Removal Means:

the chipped metal particle material from the tubing once processed against the milling head, will collect in a Working Chamber, 2 and need to be removed from the Working Chamber 2. Depending upon the isolation, washing or other features of the Working Chamber, this can be done by any number of mechanisms such as Archimedes screw, conveyor belt, gravity chute, or similar 3.

There follows descriptions of two exemplary embodiments of the invention, which are illustrative and not meant to be limiting. The tubing described is metal, but it should be mentioned that the invention can be operated to shred tubing of other types of material and not necessarily round in cross-section (e.g. square metal tubing).

### Embodiment for Mobile Processing Unit for Coiled (or Other) Tubing

The operating process steps, in a typical application of a mobile set of equipment embodying the invention, deployed for treatment of tubing at surface from spool or storage:
1. Arrive on location with equipment.
2. Identify tubing to be processed.
3. Locate tubing proximate to equipment in area to be processed, using environmental containment when required.
4. Determine if tubing-containing spool requires un-torqueing.
5. Install spool lift/un-torqueing system and prepare unit assembly for un-torqueing procedure.
6. Secure tail end of torqued tubing.
7 Proceed to un-torque tubing with un-torqueing system until entire static/potential energy is released.
8. Disconnect power source from un-torqueing unit, ensure that the spool is above the floor/ground surface and free to controllably unspool.
9. Connect tubing manipulation equipment, tube-guiding equipment, cutting face equipment, any required chip wash equipment and chip removal means to the power system of the equipment.
10. Purge tubing for hydrocarbons or other unknown hazards with wash fluid.
11. Install tail end of tubing into tubing manipulation equipment.
12. Install tubing retrieval/containment for the coolant wash/purging fluid (Working Chamber).
13. Delivered tubing will be straightened via the manipulation equipment and fed to the tubing chipping equipment through the tubing guide means.
14. Set chipping head rotary speed and tubing delivery speed to optimum efficiency of the equipment and desired chip/shard size.
15. Convey processed tubing chips into transport containment.
16. Connect tubing clamp to tail end of tubing.
17. Secure with hold back winch.
18. Cut final tail of tubing and free from spool.
19. Continue processing of tail stock.
20. Rigout equipment.
21. Tubing chips/shard packaged for shipment for recycle/remanufacture.

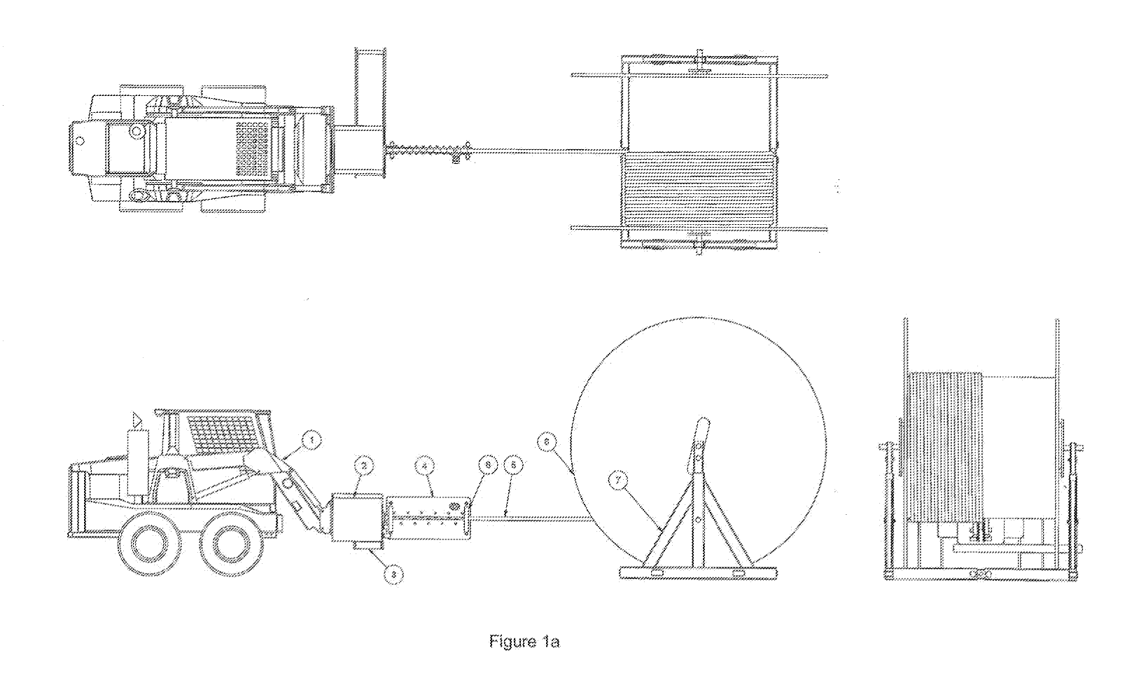

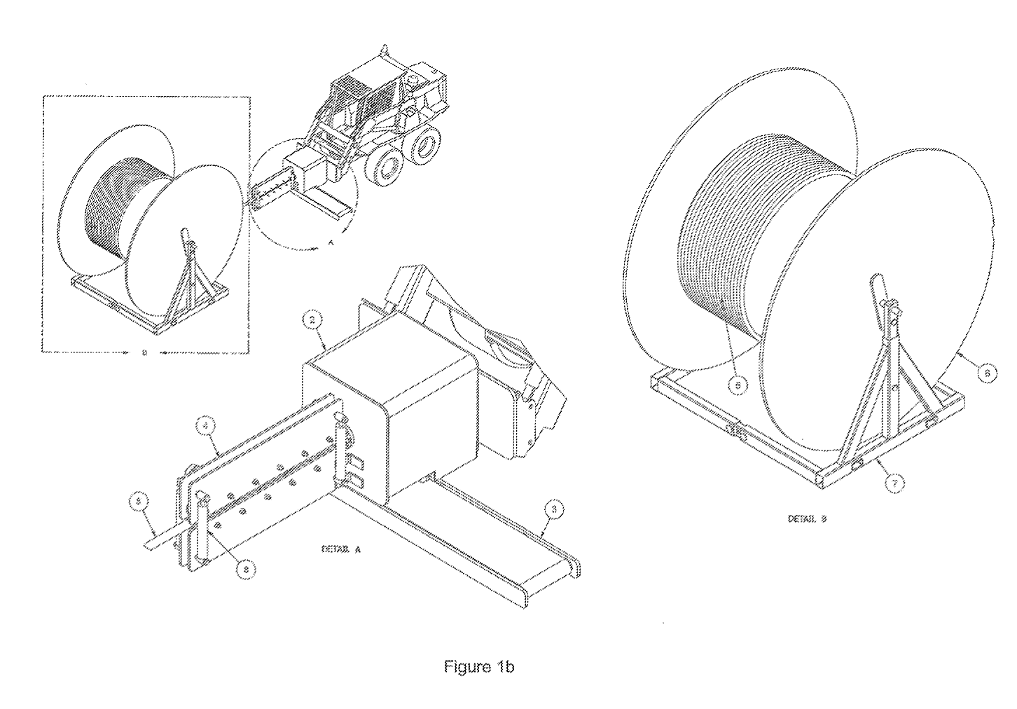

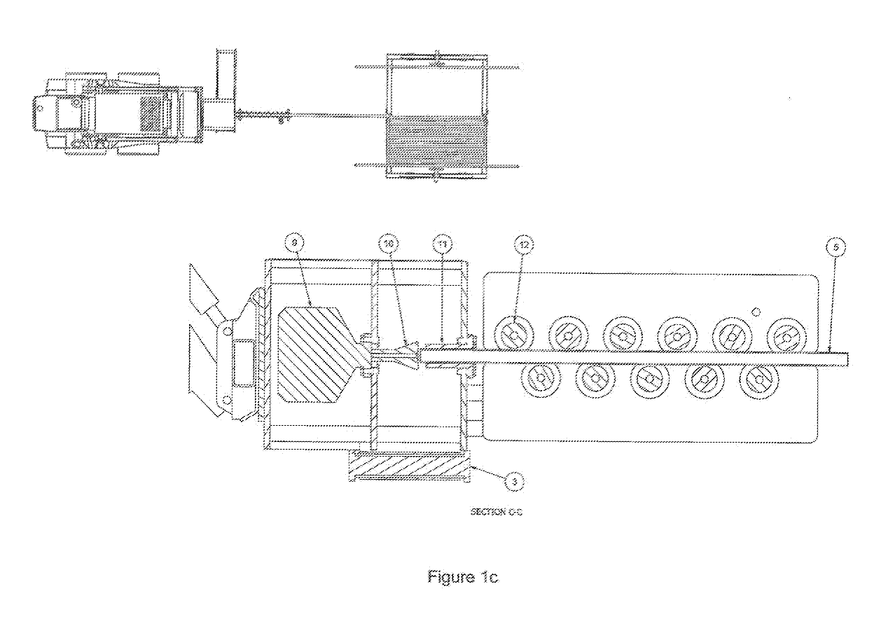

### LEGEND OF REFERENCE NUMERALS ON FIG. 1

| Number | Feature |
|---|---|
| 1 | Power pack |
| 2 | Tubing chipping system Work Chamber |
| 3 | Processed tubing conveyor system |
| 4 | Tubing delivery system |
| 5 | Tubing |
| 6 | Tubing spool |
| 7 | Tubing spool jig (hydraulic lift) |
| 8 | Tubing tensioning cylinder |
| 9 | Rotary chipping drive |
| 10 | Chipping tool assembly |
| 11 | Tubing guide |
| 12 | Tubing delivery rollers |

Embodiment for In Situ Processing of Removed Pipeline or Conduit

Recycoil operating process steps, in a typical application of a mobile set of equipment embodying the invention, deployed for treatment of tubing while pulling it from subsurface location (e.g. pipeline or underground conduit removal and treatment)
1. Arrive on location with equipment.
2. Identify tubing to be processed.
3. Expose subsurface tubing (portion at start of removal procedure) by excavation of a trench/ditch approximately 10 m×4 m and cut out and remove approximately 2 m length of tubing, leaving 2 m extending into trench from the direction of removal.
4. Lower Recycoil equipment system into trench with travelling head extended.
5. Retract travelling head back over the cut loose end of the tubing and engage the gripper/traction locking assembly onto the tubing end to secure the tubing for removal/retraction from the earth.
6. Excavate a spot at a second location up the tubing's length in the direction from which the tubing is to be removed, a calculated distance from the trench and cut end, in one embodiment up to about 1 km.
7 Cut tubing at second location excavation, thus freeing a segment of tubing at two ends (equipment end and newly cut end).
8. Engage manipulation equipment pull system to pull the tubing from its buried position in the earth and into the Recycoil equipment Working Chamber for processing.
9. Engage chipping head unit to process tubing as it is extracted.
10. When the full pull-cycle of the travelling head is complete (from full retraction to full extension), release gripper lock assembly and retract travelling head to get another grip on the tubing, closer to the extraction point from the earth exposed in the trench/ditch.
11. Continue chipping processing for another tubing pulling cycle.
12. Load chipped tubing processed product from the cutting head to a hopper and up a conveyor out of the trench/ditch for removal as a bulk, chipped product, which may be a continuous process while chips are generated.
13. When far cut-end of tubing is reached and chipped, remove Recycoil equipment from trench, move to second (next) excavation, and resume operation using these same steps, beginning at 5.
14. Repeat process as needed.

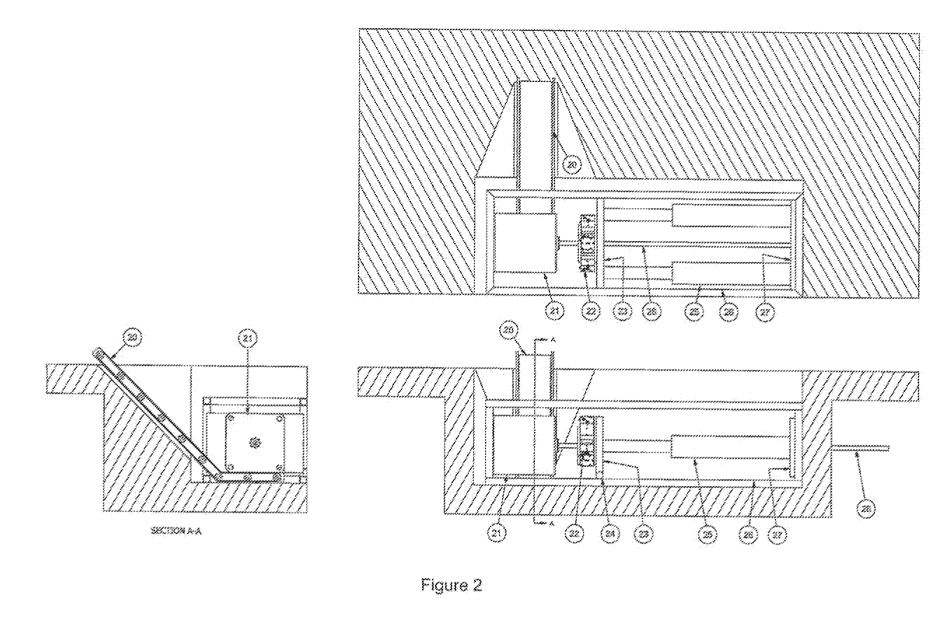

### LEGEND FOR REFERENCE NUMBERS ON FIG. 2

| Number | Feature |
|---|---|
| 20 | Conveyor/transfer for chip removal |
| 21 | Chipping head assembly |
| 22 | Gripper locking assembly |
| 23 | Travelling head plate assembly |
| 24 | Travelling head roller guide system |
| 25 | Hydraulic cylinders |
| 26 | Frame assembly |
| 27 | Base plate |
| 28 | Tubing to be removed |

What is claimed is:

1. Tubing shredding or chipping apparatus comprising:
a. Tubing receiving and manipulation means;
b. Tubing aiming and support means;
c. Cutting or shredding means;
d. Shred collection means;
e. Power to operate the cutting or shredding means;
f. Power to operate the receiving and manipulation means; and
g. Control means to control speed of introduction of tubing via aiming and support means motivated by the manipulation means; and
h. Control means to control angle at which aiming and support means present tubing to the cutting means; and
i. Control means to control distance from cutting means to aiming means; and
j. Control means to control speed and force of cutting means applied to tubing.

2. The apparatus of claim 1 where the receiving and manipulation means includes gripping means to engage the tubing to be processed.

3. The apparatus of claim 2 where the gripping means is a continuous motor-driven belt or chain or set of belts or chains faced with friction means to grip and engage the tubing and then propel the tubing in a continuous operation in a direction.

4. The apparatus of claim 3 with an added tubing straightening and guide means deployed to engage the tubing before the tubing aiming and support means engages the tubing, in operation.

5. The apparatus of claim 2 where the gripping means is a clamp or grabbing means to engage the tubing to permit the tubing to be drawn from an installed setting and into the process equipment of the apparatus, comprised of the aiming and support means, cutting or shredding means, and shred collection means, by the manipulation means, and then at the end of a stroke of the manipulation means, to release the tubing and move back to the beginning of the stroke of the manipulation means and to regrasp the tubing for another cycle of manipulation of tubing from setting into process equipment.

6. The apparatus of claim 1 with cutting removal means to remove particles formed from the tubing by the process equipment from the apparatus and its environment for further handling.

7. The apparatus of claim 1 where the collection means also isolates at least some of these from the operator or the environment:
a. Cutting means
b. Tubing
c. Shredded tubing
d. Anything in the tubing prior to introduction to cutting means
e. Washing fluids introduced to shredded tubing.

8. The apparatus of claim 1 where the shredded tubing is collected via a conveyor system and conveyed from the cutting equipment for shipment.

9. The apparatus of claim 1 where the manipulation means are powered and provided separately from the other apparatus components.

10. The apparatus of claim 1 where the cutting or shredding means comprises a rotating milling head with cutting components against which the tubing may be manipulated through the guide means.

11. A method of processing tubing for further handling or transport, comprising the steps of:
a. manipulating a loose end of the tubing to enter a tubing aiming and support means to aim the tubing's end to engage with a cutting or shredding means;
b. controlling the angle at which the tubing aiming and support means directs the tubing's end to engage with the cutting or shredding means;
c. further manipulating the tubing against the cutting or shredding means in a way which controls the speed of the tubing's travel;
d. powering the cutting or shredding means in a way which controls the cutting or shredding of the tubing as it is manipulated to engage the cutting or shredding means; and
e. containing and collecting resulting shreds or cut pieces of the tubing, resulting from its prior engagement with the cutting or shredding means.

12. The method of claim 11 for processing tubing, adapted for coiled tubing.

13. The method of claim 11 for processing tubing, adapted for segmented tubing.

14. The method of claim 11 for processing tubing from subsurface locations where the means for further manipulation of step c includes pulling the tubing from its buried location into a trench in which the process' equipment has been placed.

15. The method of claim 11 with further process step f. of washing or further treating the shreds or cut pieces of the tubing.

16. The method of claim 11 with a further process step of removing collected shreds or cut pieces of the tubing by a conveyor means for further processing.
